(19) United States
(12) Patent Application Publication
(10) Pub. No.: US 2007/0089891 A1
(43) Pub. Date: Apr. 26, 2007

(54) Anti-disengagement structure for guide balls of a striking unit

(76) Inventor: Hsin-Chi Chen, Taiping City (TW)

Correspondence Address: TROXELL LAW OFFICE PLLC, Suite 1404, 5205 LEESBURG PIKE, FALLS CHURCH, VA, 22041, US

(21) Appl. No.: 11/258,240

(22) Filed: Oct. 26, 2005

(51) Int. Cl. B23Q 5/00

(52) U.S. Cl. 173/128; 173/178

(57) ABSTRACT

An anti-disengagement structure for guide balls of a striking unit, including: a transmission shaft; a striking seat having a seat section formed with a shaft hole, the seat section being coaxially slidably fitted on the transmission shaft and reciprocally movable along the transmission shaft between a striking position and a releasing position; a guide section for guiding the seat section, the guide section including two symmetrical arced spherical depressions with predetermined arc lengths, the arced spherical depressions being formed on the seat face of the seat section and a wall of the shaft hole, the curvature centers of the spherical depressions coinciding with the axis of the shaft hole, two symmetrical guide grooves being formed on the transmission shaft respectively corresponding to the spherical depressions, two guide balls being respectively accommodated in the spherical depressions and movably inlaid in the guide grooves; and two stop sections formed on the seat face of the seat section. Inner ends of the stop sections inward protrude from the middles of the arcs of the spherical depressions and suspend above open ends of the spherical depressions on the seat face.

### BACKGROUND OF THE INVENTION

The present invention is related to a power tool, and more particularly to an anti-disengagement structure for guide balls of a striking unit.

FIGS. 1 to 3 show a striking unit 1 of a conventional power tool. The striking unit 1 includes: a transmission shaft 2 with a certain length; an output shaft 3 freely self-rotatably coaxially connected with the transmission shaft 2; a striking seat 4 fitted on the transmission shaft 2, a first end of the output shaft 3 being leant on a first face of the striking seat 4; and a guide section 5 composed of several guide balls and disposed between the striking seat 4 and the transmission shaft 2 for guiding the striking seat 4 to axially reciprocally move along the transmission seat 2 between a striking position and a releasing position. A pair of first striking blocks 6 is fixedly disposed on the first face of the striking seat 4. A pair of second striking blocks 7 radially protrudes from the first end of the output shaft 3. When the striking seat 4 is positioned in the striking position, the first striking blocks 6 can hammer the corresponding second striking blocks 7 to make the output shaft 3 self-rotate.

In the above structure, the guide balls are inlaid in corresponding guide channels for guiding the striking seat 4 to reciprocally move between the striking position and releasing position. However, in the case that a great external force is improperly applied to the striking unit 1, for example, the power tool drops onto the ground, the guide balls 8 often jump out of the guide channels. This will lead to malfunction of the power tool. The striking seat 5 is simply resiliently located in the striking position by means of a spring. Therefore, when the power tool drops onto the ground, due to impact, the guide balls tend to instantaneously jump out of the guide channels of the inner circumference of the striking seat 5. With the guide balls 8 out of the guide channels, the striking seat 5 cannot reciprocally move along the transmission shaft. As a result, the striking unit 1 becomes unable to hammer and drive the output shaft 3.

### SUMMARY OF THE INVENTION

It is therefore a primary object of the present invention to provide an anti-disengagement structure for guide balls of a striking unit, which is able to prevent the guide balls from jumping out from the guide grooves so as to ensure normal function of the striking unit.

It is a further object of the present invention to provide the above anti-disengagement structure for the guide balls of the striking unit. Without changing the basic structure of the conventional striking unit, the anti-disengagement structure is added to the conventional striking unit for truly preventing the guide balls from jumping out from the guide grooves.

According to the above objects, the anti-disengagement structure for the guide balls of the striking unit of the present invention includes:

a transmission shaft having a predetermined outer diameter;

a striking seat having a seat section, the seat section being formed with a shaft hole with a predetermined inner diameter, the shaft hole axially extending through the seat section from a seat face thereof to another face of the seat section, the seat section being coaxially slidably fitted on the transmission shaft, whereby the seat section can be reciprocally moved along an axis of the transmission shaft between a striking position and a releasing position; and

a guide section for guiding the seat section to reciprocally move between the striking position and releasing position, the guide section including two symmetrical arced spherical depressions with predetermined arc lengths, the arced spherical depressions being formed on the seat face of the seat section and a wall of the shaft hole, the curvature centers of the spherical depressions coinciding with the axis of the shaft hole, two symmetrical guide grooves being formed on the transmission shaft respectively corresponding to the spherical depressions, two guide balls being respectively accommodated in the spherical depressions and movably inlaid in the guide grooves.

The anti-disengagement structure is characterized in that two stop sections are formed on the seat face of the seat section, inner ends of the stop sections inward protruding from the middles of the arcs of the spherical depressions and suspending above open ends of the spherical depressions on the seat face, whereby the inner ends of the stop sections partially block the open ends of the spherical depressions to prevent the guide balls from jumping out from the open ends of the spherical depressions.

The present invention can be best understood through the following description and accompanying drawings wherein:

### BRIEF DESCRIPTION OF THE DRAWINGS

FIG. 1 is a perspective view of a conventional striking seat;

FIG. 2 is a sectional view of a conventional striking unit;

FIG. 3 is a sectional view according to FIG. 2, showing that the guide balls jump out of the guide channels;

FIG. 4 is a perspective exploded view a first embodiment of the present invention;

FIG. 5 is a perspective assembled view the first embodiment of the present invention;

FIG. 6 is a sectional view taken along line 6-6 of FIG. 5, showing that the striking seat is positioned in the striking position;

FIG. 7 is a sectional view according to FIG. 6, showing that the striking seat is moved to a lower dead end when dropping onto the ground;

FIG. 8 is a perspective view the striking seat of a second embodiment of the present invention;

FIG. 9 is a perspective view the striking seat of a third embodiment of the present invention;

FIG. 10 is a perspective view the striking seat of a fourth embodiment of the present invention; and

FIG. 11 is a sectional view taken along line 11-11 of FIG. 10.

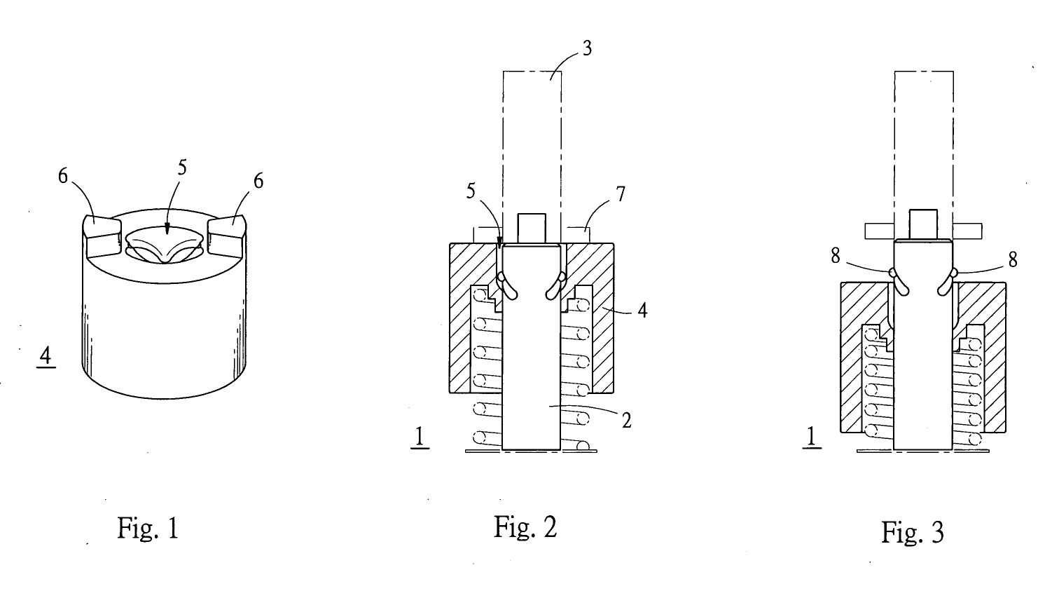

### DETAILED DESCRIPTION OF THE PREFERRED EMBODIMENTS

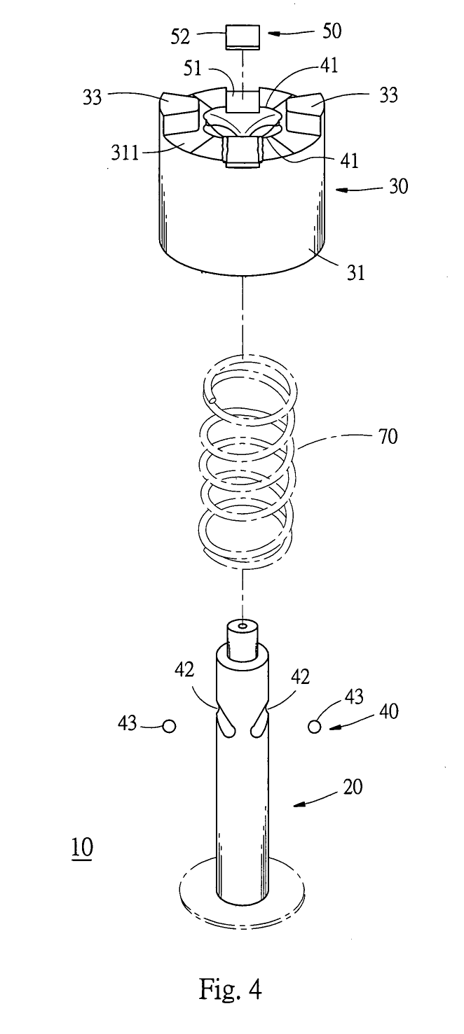

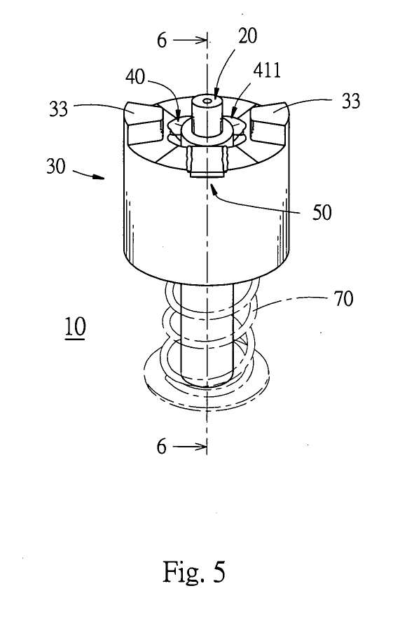

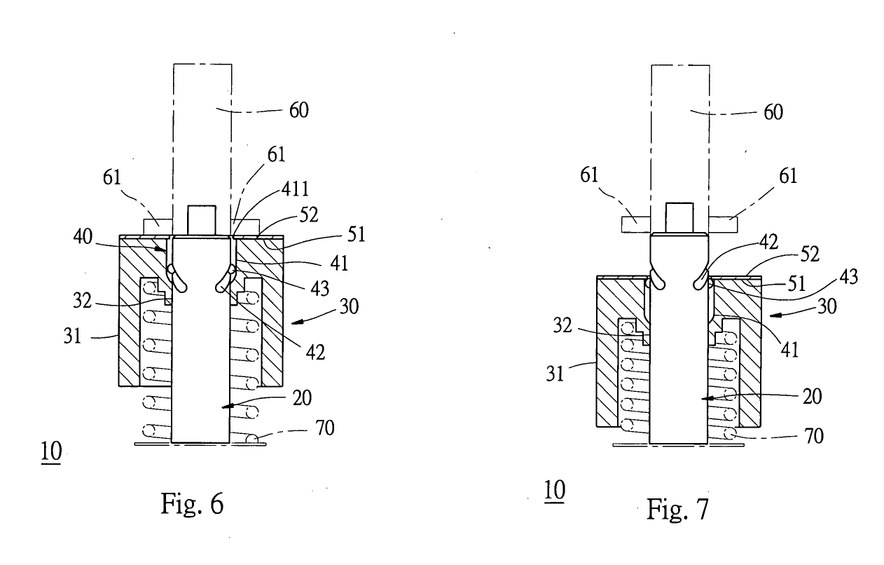

Please refer to FIGS. 4 to 7. The anti-disengagement structure 10 for the guide balls of the striking unit of the present invention includes a transmission shaft 20, a striking seat 30, a guide section 40 and two stop sections 50.

The transmission shaft 20 has a certain length and a uniform diameter.

The striking seat 30 has a cylindrical seat section 31. The seat section 31 is formed with a shaft hole 32 axially extending through the seat section 31 from a seat face 311 to another face of the seat section 31. The shaft hole 32 has a diameter corresponding to the diameter of the transmission shaft 20. The seat section 31 is coaxially slidably fitted on the transmission shaft 20, whereby the seat section 31 can be linearly reciprocally moved along an axis of the transmission shaft 20 between a striking position and a releasing position.

The guide section 40 includes two symmetrical arced spherical depressions 41 formed on the seat face of the seat section and the wall of the shaft hole. The arc of each spherical depression 41 is smaller than 180 degrees. The curvature centers of the spherical depressions 41 coincide with the axis of the shaft hole 32. The arcs of the spherical depressions 41 are inward tapered. Two substantially reverse V-shaped guide grooves 42 are respectively formed on two sides of the transmission shaft 20 corresponding to the spherical depressions 41. The guide grooves 42 and the spherical depressions 41 together define therebetween a receiving space. Two guide balls 43 are respectively accommodated in the spherical depressions 41 and movably inlaid in the guide grooves 42.

The guide section 40 is able to guide the seat section 31 to move between the striking position and the releasing position. This operation pertains to prior art and thus will not be further described hereinafter.

Each stop section 50 has a rectangular insertion sink 51 with a certain depth. The insertion sinks 51 are formed on the seat face 311 with their lengths normal to the axis of the shaft hole 32. A rectangular stop plate 52 is fixedly inlaid and connected in each insertion sink 51. The stop plate 52 has a length larger than the length of the insertion sink 51. An inner end of the stop plate 52 inward extends from the middle of the arc of the spherical depression 41 toward the axis of the shaft hole 32. Accordingly, the inner end of the stop plate 52 inward protrudes and suspends above an open end 411 of the spherical depression 41 on the seat face 311. Therefore, the inner end of the stop plate 52 provides a stopping effect in the middle of the open end 411 of the spherical depression 41 within a certain range. Two sides of the open end 411 are free from the stop and form a free space. The free space has a maximum inner diameter larger than the diameter of the guide ball 43.

The above structure is assembled with a conventional output shaft 60 and a spring 70 to form a striking unit. The transmission shaft 20 is driven by an external power supply and the guide section 40 serves to guide the striking seat 30 to move between the striking position and the releasing position. In the striking position, the sector-shaped striking blocks 33 formed on the seat face 311 of the striking seat 30 can hammer the anvils 61 of one end of the output shaft 60. Accordingly, the output shaft 60 can rotate to output power.

In precondition of no affection on the guiding function of the guide section 40, the stop plates 52 of the stop sections 50 inward protrude by a certain length to provide a partially stopping effect. In case that the striking unit 10 is incautiously dropped onto the ground or instantaneously impacted, the guide balls 43 are restricted by the stop plates 52 from jumping out of the spherical depressions 41. Therefore, the guide balls 43 can keep accommodated in the spherical depressions 41.

It should be noted that the stop sections 50 only partially block the open end 411 of the spherical depressions 41. Therefore, the guide balls 43 can normally move in a guiding path within the spherical depressions 41 to guide the striking seat 30 without being affected by the stop sections 50. Therefore, without changing the basic structure of the conventional striking unit, the stop sections 50 are added to the conventional striking unit for achieving the anti-disengagement effect.

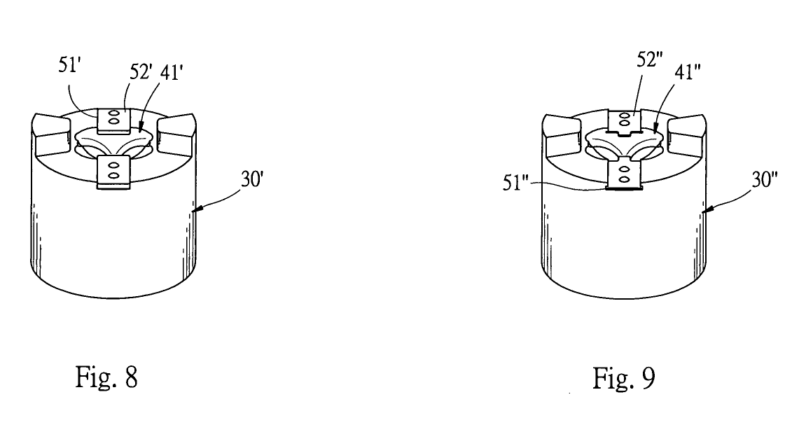

In the above first embodiment, the stop plate is point-welded in the insertion sink. Alternatively, FIG. 8 shows a second embodiment of the present invention, in which the stop plate 52′ is riveted in the insertion sink 51′. This can achieve the same effect as the first embodiment.

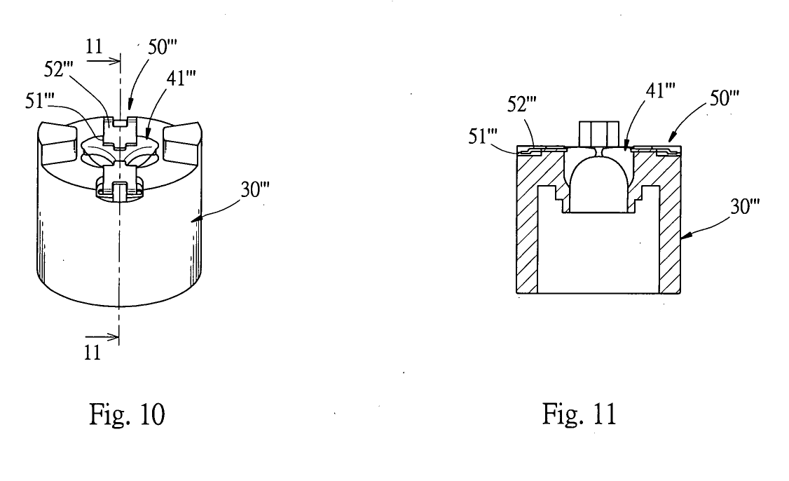

FIGS. 9 to 11 show a third and a fourth embodiments of the present invention, in which the stop plates 52″, 52′″ have a thickness smaller than that of the stop plates of the first and second embodiments. In addition, the stop plates 52″, 52′″ are substantially reverse T-shaped and located in the corresponding insertion sinks 51″, 51′″. FIG. 9 shows that the stop plate 52″ of the third embodiment is riveted in the insertion sink 51″. FIGS. 10 and 11 show that the other end of the stop plate 52′″ of the fourth embodiment is resiliently bent and located in the insertion sink 51′″. This facilitates the assembly of the stop plate 52′″.

The above embodiments are only used to illustrate the present invention, not intended to limit the scope thereof. Many modifications of the above embodiments can be made without departing from the spirit of the present invention.

What is claimed is:

1. An anti-disengagement structure for guide balls of a striking unit, comprising:
a transmission shaft having a predetermined outer diameter;
a striking seat having a seat section, the seat section being formed with a shaft hole with a predetermined inner diameter, the shaft hole axially extending through the seat section from a seat face thereof to another face of the seat section, the seat section being coaxially slidably fitted on the transmission shaft, whereby the seat section can be reciprocally moved along an axis of the transmission shaft between a striking position and a releasing position; and
a guide section for guiding the seat section to reciprocally move between the striking position and releasing position, the guide section including two symmetrical arced spherical depressions with predetermined arc lengths, the arced spherical depressions being formed on the seat face of the seat section and a wall of the shaft hole, the curvature centers of the spherical depressions coinciding with the axis of the shaft hole, two symmetrical guide grooves being formed on the transmission shaft respectively corresponding to the spherical depressions, two guide balls being respectively accommodated in the spherical depressions and movably inlaid in the guide grooves, said anti-disengagement structure being characterized in that two stop sections are formed on the seat face of the seat section, inner ends of the stop sections inward protruding from the middles of the arcs of the spherical depressions and suspending above open ends of the spherical depressions on the seat face, whereby the inner ends of the stop sections partially block the open ends of the spherical depressions to prevent the guide balls from jumping out from the open ends of the spherical depressions.

2. The anti-disengagement structure for the guide balls of the striking unit as claimed in claim 1, wherein each stop section includes an elongated stop plate, an inner end of the stop plate inward protruding and suspending above the open end of the corresponding spherical depression on the seat face.

3. The anti-disengagement structure for the guide balls of the striking unit as claimed in claim 2, wherein each stop section further includes an insertion sink with a predetermined depth, the insertion sink being formed on the seat face, the stop plate being inlaid in the insertion sink.

4. The anti-disengagement structure for the guide balls of the striking unit as claimed in claim 3, wherein the stop plate is fixedly inlaid and connected in the corresponding insertion sink.

5. The anti-disengagement structure for the guide balls of the striking unit as claimed in claim 3, wherein the insertion sinks are reverse T-shaped.

6. The anti-disengagement structure for the guide balls of the striking unit as claimed in claim 1, wherein two sides of the open end of the spherical depression on the seat face are free from the stop of the stop section to form a free space, the free space having an inner diameter at least equal to the diameter of the guide ball.

7. The anti-disengagement structure for the guide balls of the striking unit as claimed in claim 1, wherein the arcs of the spherical depressions are smaller than 180 degrees.
